(19) United States
(12) Patent Application Publication
(10) Pub. No.: US 2025/0265696 A1
(43) Pub. Date: Aug. 21, 2025

(54) INSPECTION DEVICE AND INSPECTION METHOD

(71) Applicant: ANRITSU CORPORATION, Kanagawa (JP)

(72) Inventor: Lawrence Earl CARANDANG, Kanagawa (JP)

(21) Appl. No.: 19/058,990

(22) Filed: Feb. 20, 2025

(30) Foreign Application Priority Data
Feb. 21, 2024 (JP) JP2024-024693

(51) Int. Cl. G06T 7/00; G01N 23/04; G01N 23/083

(52) U.S. Cl. CPC G06T 7/0004; G01N 23/04; G01N 23/083; G01N 2223/401; G06T 2207/10116; G06T 2207/20081; G06T 2207/20084; G06T 2207/30108; G06T 2207/30168

(57) ABSTRACT

There is provided an inspection device including: a camera that captures an image of an inspection object to acquire image data; image inference means for outputting a determination result indicating a quality of the inspection object based on the input image data; and domain adaptation means for outputting adapted image data, which is adapted to a distribution of learning image data used for model generation by the image inference means, based on first image data obtained by capturing the image of the inspection object and metadata indicating a distribution of the first image data.

### TECHNICAL FIELD

The present invention relates to an inspection device and an inspection method.

### BACKGROUND ART

As an inspection method for an object such as a product, there is a method using an inspection image obtained by image capturing. A camera captures an image of an object moving on a conveyor, and inspection as to whether or not a foreign object appears in an inspection image obtained by image capturing is performed.

Patent Document 1 discloses an inspection device. The inspection device includes an image storage unit that captures a plurality of images of an inspection object W under a predetermined capturing condition corresponding to each input system included in different input systems and stores a plurality of inspection images obtained by image capturing as a set of the plurality of images of the inspection object, and a determination unit that performs processing on the plurality of inspection images stored in the image storage unit for each pixel based on a learning model created in advance by performing learning using images having the same capturing condition as the plurality of inspection images, obtains a quality defect level, and determines a quality state of the inspection object by comparing the quality defect level with a preset threshold value.

### RELATED ART DOCUMENT

### Patent Document

[Patent Document 1] JP-A-2023-114828

### DISCLOSURE OF THE INVENTION

### Problem that the Invention is to Solve

In an inspection device having a type that inputs an inspection image obtained by capturing an image of an inspection object to a learning model and obtains a determination result, in many cases, an image of the inspection object is captured under a capturing condition different from the capturing conditions used when creating the learning model, and inspection is performed. A place where the learning model is created and a site such as a factory where the actual inspection is performed may be different. Therefore, brightness of illumination in a case of capturing an image of the inspection object may differ, or a setting value of the camera may differ.

Here, performance of the learning model is generally measured by ability to generalize unknown data. Each of the unknown data and data used for machine learning belongs to a specific distribution as compared with available range of gradation. In this case, in a case where an image that belongs to significantly changed distribution is input to the learning model, an output result of the learning model may not be able to maintain high accuracy. Therefore, even in a case where the distribution of the input image is significantly changed, in order to maintain high accuracy, it may be necessary to perform relearning of the learning model.

However, in a case where the inspection device is once implemented on a site such as a factory and then relearning is performed, this work requires acquisition of inspection images belonging to a new distribution, and as a result, it takes a lot of time and cost. In addition, inspection cannot be performed at a site such as a factory until relearning is completed, and as a result, production downtime occurs.

The present invention has been made in view of the above circumstances, and an object of the present invention is to provide an inspection device and an inspection method capable of reducing a cost for relearning and production downtime.

### Means for Solving the Problem

In order to achieve the above object, according to a first aspect of the present invention, there is provided an inspection device including: a camera that captures an image of an inspection object to acquire image data; image inference means for outputting a determination result indicating a quality of the inspection object based on the input image data; and domain adaptation means for outputting adapted image data, which is adapted to a distribution of learning image data used for model generation by the image inference means, based on first image data obtained by capturing the image of the inspection object and metadata indicating a distribution of the first image data.

According to a second aspect of the present invention, in the inspection device according to the first aspect, the camera may capture the image of the inspection object transported by transporting means.

According to a third aspect of the present invention, in the inspection device according to the first aspect, the metadata may include information indicating a capturing condition in a case where the camera captures the image of the inspection object.

According to a fourth aspect of the present invention, in the inspection device according to the third aspect, the information indicating the capturing condition may include a value indicating characteristics of a light source in a case of capturing the image of the inspection object or a setting value of the camera in a case of capturing the image of the inspection object.

According to a fifth aspect of the present invention, in the inspection device according to the first aspect, the domain adaptation means may include a neural network receiving the first image data and the metadata as inputs and outputting the adapted image data.

According to a sixth aspect of the present invention, in the inspection device according to the fifth aspect, the neural network may include an embedding network for embedding predetermined calibration parameters based on the metadata.

According to a seventh aspect of the present invention, in the inspection device according to the first aspect, the camera is an X-ray camera, and the image data is transmission image data of the inspection object.

According to an eighth aspect of the present invention, the inspection device according to the first aspect may further include selection means for determining which of the first image data or the adapted image data is to be used as input data for the image inference means. In addition, according to a ninth aspect of the present invention, the inspection device according to the second aspect may further include selection means for determining which of the first image data or the adapted image data is to be used as input data for the image inference means. In addition, according to a tenth aspect of the present invention, the inspection device according to the third aspect may further include selection means for determining which of the first image data or the adapted image data is to be used as input data for the image inference means. In addition, according to an eleventh aspect of the present invention, the inspection device according to the fourth aspect may further include selection means for determining which of the first image data or the adapted image data is to be used as input data for the image inference means. In addition, according to a twelfth aspect of the present invention, the inspection device according to the fifth aspect may further include selection means for determining which of the first image data or the adapted image data is to be used as input data for the image inference means. In addition, according to a thirteenth aspect of the present invention, the inspection device according to the sixth aspect may further include selection means for determining which of the first image data or the adapted image data is to be used as input data for the image inference means. In addition, according to a fourteenth aspect of the present invention, the inspection device according to the seventh aspect may further include selection means for determining which of the first image data or the adapted image data is to be used as input data for the image inference means.

According to a fifteenth aspect of the present invention, there is provided an inspection method of an inspection object by an inspection device including a camera that captures an image of the inspection object to acquire image data and image inference means for outputting a determination result indicating a quality of the inspection object based on the input image data, the inspection method including: a step of acquiring first image data obtained by capturing the image of the inspection object via the camera; a domain adaptation step of outputting adapted image data, which is adapted to a distribution of learning image data used for model generation by the image inference means, based on the first image data and metadata indicating a distribution of the first image data; and an image inference step of inputting the adapted image data to the image inference means and outputting the determination result indicating the quality of the inspection object.

According to a sixteenth aspect of the present invention, in the inspection method according to the fifteenth aspect, the metadata may include information indicating a capturing condition in a case where the camera captures the image of the inspection object.

According to a seventeenth aspect of the present invention, in the inspection method according to the sixteenth aspect, the information indicating the capturing condition may include a value indicating characteristics of a light source in a case of capturing the image of the inspection object or a setting value of the camera in a case of capturing the image of the inspection object.

### [Advantage of the Invention]

According to the present invention, it is possible to provide an inspection device and an inspection method capable of reducing a cost for relearning and production downtime.

### BRIEF DESCRIPTION OF THE DRAWINGS

FIG. 1 is a block diagram illustrating an inspection device according to an embodiment of the present disclosure.

FIG. 2 is a conceptual diagram illustrating learning and inference of a learning model according to the embodiment of the present disclosure.

FIG. 3 is a conceptual diagram showing a table indicating a correspondence relationship between information indicating a capturing condition and image data.

FIG. 4 is a conceptual diagram illustrating a configuration example of a domain adaptation model implemented in a domain adaptation unit according to the embodiment of the present disclosure.

### BEST MODE FOR CARRYING OUT THE INVENTION

Hereinafter, an embodiment of the present invention will be described in detail with reference to the drawings.

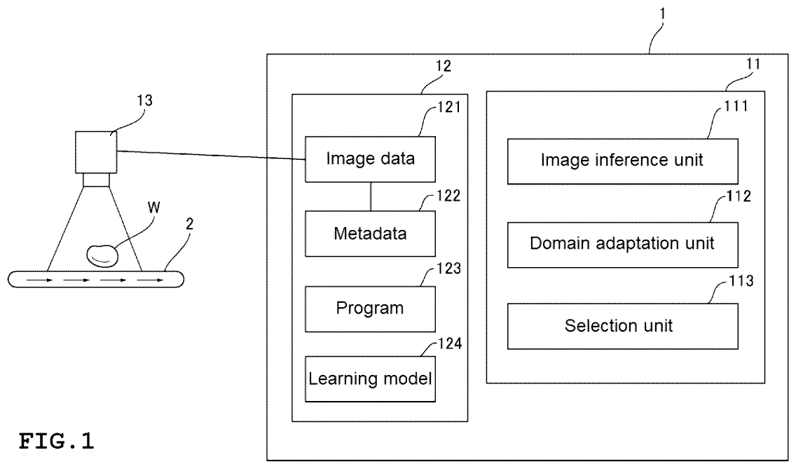

FIG. 1 is a block diagram illustrating an inspection device according to an embodiment of the present disclosure.

The inspection device 1 includes a processor 11, a storage device 12, and a camera 13.

The processor 11 is configured using, for example, a central processing unit (CPU), a micro processing unit (MPU), a digital signal processor (DSP), or a field programmable gate array (FPGA).

A memory included in the storage device 12 stores a program to be executed by the processor 11 and various types of data to be used when the program is executed. The memory may include an HDD, a ROM, a RAM, and the like, and stores various programs (an OS, application software, and the like) to be executed by the processor 11 and various types of data.

The storage device 12 stores image data 121, metadata 122, a program 123, and a learning model 124.

The camera 13 captures an image of an inspection object W. The storage device 12 stores image data obtained by image capturing. During a period for which the camera 13 captures an image, a light source may illuminate the inspection object W. The light source may be a dedicated light, a ceiling illuminator, an external light source, or the like. The camera 13 is, for example, a general camera, an X-ray camera, or a near-infrared camera. The general camera captures an appearance image of the inspection object W. The X-ray camera captures a transmission image of the inspection object W. The near-infrared camera captures an appearance image or a transmission image of the inspection object W.

A conveyor 2 may be used to transport the inspection object W. The conveyor 2 transports the inspection object W. The inspection object W is, for example, a product. A foreign object may be contained in the product on the conveyor 2.

In a case where the processor 11 reads and executes a program 123 stored in the storage device 12, the processor 11 functions as an image inference unit 111, a domain adaptation unit 112, and a selection unit 113.

The image inference unit 111 receives the image data as an input, and outputs a determination result indicating a quality of the inspection object W. The quality of the inspection object W may mean whether the inspection object W is a foreign object or a target product. The quality of the inspection object W may mean whether or not the inspection object W has a defect. Note that the image inference unit 111 may receive the image data as an input and perform a task of classifying a type of an object appearing in the image.

The domain adaptation unit 112 outputs adapted image data, which is adapted to a distribution of the image data used for model generation by the image inference unit 111, based on first image data and metadata indicating a distribution of the first image data.

The domain adaptation unit 112 includes a neural network receiving the first image data and the metadata as inputs and outputting adapted image data. The neural network may be stored in the storage device 12 as the learning model 124, and the processor 11 loads the learning model 124 from the storage device 12.

The selection unit 113 determines which of the first image data or the adapted image data is to be used as the input data for the image inference unit 111.

The inspection device 1 may include input means (not illustrated). Alternatively, the inspection device 1 may be connected to input means. The input means is used by a user to input information. The input means may include a mouse, a keyboard, a touch panel, and the like, and is not limited thereto. The user may designate which of the first image data or the adapted image data is to be used as the input data for the image inference unit 111 via the input means. In addition, the user may instruct or select content of various types of information processing of the inspection device 1 via the input means.

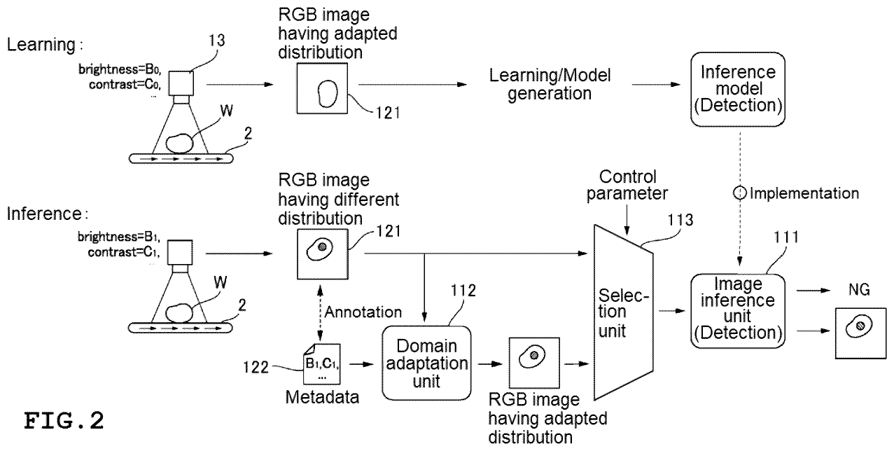

FIG. 2 is a conceptual diagram illustrating learning and inference of the learning model according to the embodiment of the present disclosure.

### Learning Stage

First, a learning stage will be described. The camera 13 captures an image of the inspection object W transported by the conveyor 2. Thereby, first image data (also referred to as learning image data) is acquired. The first image data is, for example, an RGB image having a distribution to be an adaptation target. Here, content of the image data may differ depending on a type of the camera, such as an X-ray camera.

Information indicating a capturing condition included in the metadata may include a value indicating characteristics of the light source when capturing an image of the inspection object W or a setting value of the camera 13 when capturing an image of the inspection object W. The value indicating the characteristics of the light source may be a value which is assigned in advance by those skilled in the art, such as a value indicating that a ceiling illuminator is a white light source or a value indicating that an external light source is used. The setting value of the camera 13 includes, for example, brightness, contrast, an F number, and the like, and is not limited thereto. In FIG. 2, brightness=B₀ and contrast=C₀ are exemplified as the information indicating the capturing condition. Note that a domain corresponding to the capturing condition when performing learning is referred to as an original domain. The domain refers to a type of a distribution of the image data obtained by capturing an image of the inspection object.

Next, machine learning is performed by using the acquired image data as learning data. Thereby, a learning model is generated. The generated learning model is an inference model receiving the image data as an input and outputting a determination result indicating a quality of the inspection object.

The inference model generated as described above is stored in the storage device 12 of the inspection device 1 as the learning model 124.

### Inference Stage

Next, an inference stage will be described. In the inference stage, the inference model generated in the learning stage is used.

The camera 13 captures an image of the inspection object W transported by the conveyor 2. Thereby, the first image data is acquired. The first image data is, for example, an RGB image having a different distribution. Here, the content of the image data may differ depending on the type of the camera, such as an X-ray camera. The inspection device 1 stores the first image data obtained by image capturing in the storage device 12 as image data 121.

The type of the information indicating the capturing condition included in the metadata is the same as in the learning stage. Here, the capturing condition may be different between the learning stage and the inference stage. For example, in the learning stage, brightness=B₀ and contrast=C₀ are set, but in the inference stage performed in a factory or the like, brightness=B₁ and contrast=C₁ are set. Note that the domain corresponding to the capturing condition when performing inference is referred to as a different domain. The domain refers to a type of a distribution of the image data obtained by capturing an image of the inspection object.

The inspection device 1 stores information indicating various capturing conditions in the storage device 12 as the metadata 122 in advance. The information indicating the capturing condition in the learning stage may also be included in the metadata 122.

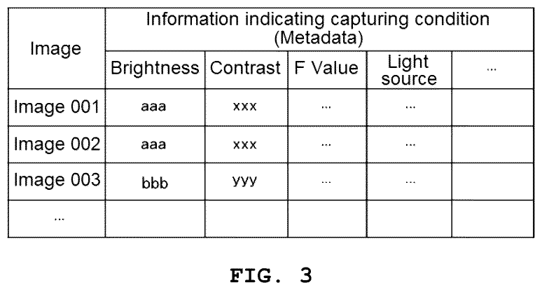

The inspection device 1 annotates the first image data, which is obtained by image capturing in the inference stage, with the information that indicates the capturing condition in the inference stage and is included in the metadata 122. The annotation refers to storing information such that a correspondence relationship between the information indicating the capturing condition and the image data can be specified. For example, the inspection device 1 may store a table indicating a correspondence relationship between the information indicating the capturing condition and the image data, in the storage device 12. FIG. 3 is a conceptual diagram showing a table indicating a correspondence relationship between the information indicating the capturing condition and the image data. In the table shown in FIG. 3, the image 001 and the information indicating the capturing condition (brightness=aaa, contrast=xxx, . . . ) are annotated with each other.

Refers again to FIG. 2. As already described, a place where the learning model is created and a site such as a factory where the actual inspection is performed may be different. Therefore, the capturing condition may be different between the learning stage and the inference stage.

It is also conceivable that the distribution of the input image which is input to the learning model is greatly changed due to a change in the capturing condition. In such a case, it may be necessary to perform relearning of the learning model in order to maintain high accuracy. However, in a case where the inspection device is once implemented on a site such as a factory and then relearning is performed, this work requires acquisition of inspection images belonging to a new distribution, and as a result, it takes a lot of time and cost. In addition, inspection cannot be performed at a site such as a factory until relearning is completed, and as a result, production downtime occurs.

Therefore, in the embodiment of the present disclosure, the input data for the learning model is adapted to the distribution of the image data used for model generation by the image inference unit 111. In addition, the adapted image data is input to the image inference unit 111. The domain adaptation unit 112 adapts the image data acquired in a different domain to an image included in a domain corresponding to the original domain. Thus, it is possible to continue the determination with high accuracy without performing relearning described above. Therefore, it is possible to reduce time and cost for relearning.

Further, relearning can be performed in parallel while operating the inspection device 1 at a site such as a factory. In addition, after relearning is completed, the learning model obtained by performing relearning is implemented again in the inspection device 1. Thereby, it is possible to reduce production downtime until relearning is completed.

In order to implement the above configuration, the domain adaptation unit 112 outputs, based on the RGB image having a different distribution, which is the first image data, and the metadata 122 indicating the distribution of the RGB image having a different distribution, the adapted image data that is adapted to the distribution of the RGB image having an adaptation target distribution which is image data used for model generation by the image inference unit 111. In addition, the inspection device 1 inputs the adapted image data to the image inference unit 111. Thereby, a determination result indicating a quality of the inspection object W is acquired. The selection unit 113 will be described below.

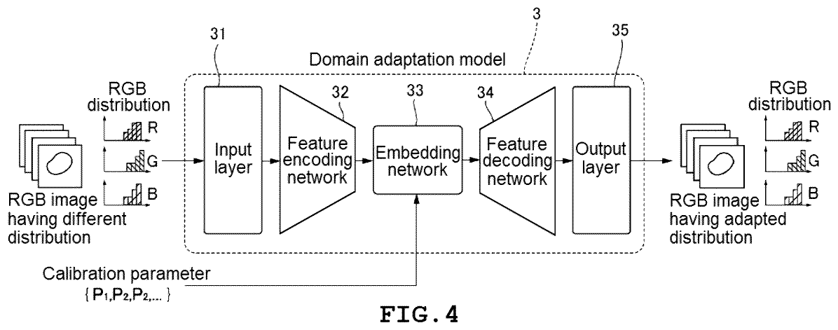

FIG. 4 is a conceptual diagram illustrating a configuration example of a domain adaptation model implemented in the domain adaptation unit according to the embodiment of the present disclosure.

The domain adaptation unit 112 includes a neural network receiving the first image data and the metadata 122 as inputs and outputting the adapted image data. In the present specification, the neural network is referred to as a domain adaptation model.

The domain adaptation model 3 includes an input layer 31, a feature encoding network 32, an embedding network 33, a feature decoding network 34, and an output layer 35. An image having a specific distribution is input to the input layer 31. In the present example, an RGB image having a different distribution is input. The distribution means, for example, a distribution shown as a density histogram. The specific distribution is typically a distribution of the image data captured in a different domain when performing the inference stage.

The image data which is input to the input layer 31 is encoded by the feature encoding network 32. The feature encoding network 32 includes general layers such as a convolutional layer and a pooling layer.

The embedding network 33 is a network in which an influence of calibration parameters on the information encoded by the feature encoding network 32 is embedded. The calibration parameters {p1, p2, p2, . . . } are parameters determined according to the information indicating the capturing condition included in the metadata 122. That is, the calibration parameters which are different depending on the capturing condition are embedded in the embedding network 33. The calibration parameters may include one or more numerical values.

As a specific processing example of the embedding, the embedding may be performed in a manner in which addition, subtraction, multiplication, or division is performed on a value of each layer included in the embedding network 33 by using a value based on the calibration parameter. Here, the present disclosure is not limited thereto, and the embedding may be performed by a method that is generally used by those skilled in the art, such as a method of embedding external parameters into the embedding network.

The feature decoding network 34 performs decoding on the information output from the embedding network 33.

The output layer 35 outputs the image data having the adapted distribution that is obtained by performing decoding. In the present example, the RGB image adapted to the target distribution is output from the output layer 35.

Note that, although the domain adaptation model 3 using a method of embedding the calibration parameters into the embedding network 33 has been described, the domain adaptation model 3 may use other algorithms. For example, an algorithm that mixes a weight corresponding to a value based on the calibration parameter into any layer other than the embedding network 33 in the neural network included in the domain adaptation model 3 may be used. A known style transfer technique may be applied to the input image data to perform style conversion to a style based on the calibration parameter. Depending on the algorithm, the calibration parameter may be image data.

### Selection Unit

Refer again to FIG. 2. As described above, by inputting the image data after adaptation of the domain to the image inference unit 111, it is possible to continue the determination with high accuracy without performing relearning described above. On the other hand, in a case where the capturing conditions are similar to each other between the learning stage and the inference stage, it may be possible to perform determination with high accuracy without performing adaptation of the image data by the domain adaptation unit 112.

Therefore, the selection unit 113 may determine which of the first image data or the adapted image data is to be used as the input data for the image inference unit 111.

The input data for the image inference unit 111 may be determined by the selection unit 113 based on, for example, a user selection. A control parameter is input to the selection unit 113 based on a user input which is input via the input means (not illustrated). The selection unit 113 determines whether the input data for the image inference unit 111 is the first image data or the adapted image data based on the user selection indicated by the control parameter.

Note that the selection unit 113 may determine whether the input data for the image inference unit 111 is the first image data or the adapted image data, regardless of the user selection. For example, the selection unit 113 analyzes the information indicating the capturing condition annotated with the RGB image having a different distribution that is captured in the inference stage. In the present example, the selection unit 113 analyzes the information indicating the capturing condition of brightness=B₁ and contrast=C₁. As a result of the analysis, in a case where a difference between the original domain and the other domain is small, the selection unit 113 may determine that the first image data is the input data for the image inference unit 111. For the difference between the original domain and the other domain, a numerical value indicating a feature of the original domain is calculated, and a numerical value indicating a feature of the other domain is calculated. In a case where a difference between the numerical values is smaller than a predetermined threshold value, the selection unit 113 may determine that the difference between the original domain and the other domain is small.

Note that, in the example illustrated in FIG. 2, processing related to the selection unit 113 is performed after processing related to the domain adaptation unit 112 is completed. On the other hand, the selection unit 113 may determine whether the input data for the image inference unit 111 is the first image data or the adapted image data before performing the processing related to the domain adaptation unit 112. Thus, in a case where it is determined that the input data for the image inference unit 111 is the first image data, the adaptation processing related to the domain adaptation unit 112 may be skipped.

Although various embodiments have been described above with reference to the drawings, it goes without saying that the present disclosure is not limited to such examples. It will be apparent to those skilled in the art that various modifications or alterations may be made within the scope of the claims, and it will be understood that these modifications or alterations also naturally fall within the technical scope of the present disclosure. For example, the steps of the method according to the present disclosure may be performed in any order as long as there is no contradiction. In addition, the components in the above-described embodiments may be combined in any manner without departing from the spirit of the present disclosure.

### DESCRIPTION OF REFERENCE NUMERALS AND SIGNS

1: inspection device
11: processor
111: image inference unit
112: domain adaptation unit
113: selection unit
12: storage device
121: image data
122: metadata
123: program
124: learning model
13: camera
2: conveyor
3: domain adaptation model
31: input layer
32: feature encoding network
33: embedding network
34: feature decoding network
35: output layer
W: inspection object

What is claimed is:

1. An inspection device comprising:
a camera that captures an image of an inspection object to acquire image data;
image inference means for outputting a determination result indicating a quality of the inspection object based on the input image data; and
domain adaptation means for outputting adapted image data, which is adapted to a distribution of learning image data used for model generation by the image inference means, based on first image data obtained by capturing the image of the inspection object and metadata indicating a distribution of the first image data.

2. The inspection device according to claim 1,
wherein the camera captures the image of the inspection object transported by transporting means.

3. The inspection device according to claim 1,
wherein the metadata includes information indicating a capturing condition in a case where the camera captures the image of the inspection object.

4. The inspection device according to claim 3,
wherein the information indicating the capturing condition includes a value indicating characteristics of a light source in a case of capturing the image of the inspection object or a setting value of the camera in a case of capturing the image of the inspection object.

5. The inspection device according to claim 1,
wherein the domain adaptation means includes a neural network receiving the first image data and the metadata as inputs and outputting the adapted image data.

6. The inspection device according to claim 5,
wherein the neural network includes an embedding network for embedding predetermined calibration parameters based on the metadata.

7. The inspection device according to claim 1,
wherein the camera is an X-ray camera, and the image data is transmission image data of the inspection object.

8. The inspection device according to claim 1, further comprising:
selection means for determining which of the first image data or the adapted image data is to be used as input data for the image inference means.

9. The inspection device according to claim 2, further comprising:
selection means for determining which of the first image data or the adapted image data is to be used as input data for the image inference means.

10. The inspection device according to claim 3, further comprising:
selection means for determining which of the first image data or the adapted image data is to be used as input data for the image inference means.

11. The inspection device according to claim 4, further comprising:
selection means for determining which of the first image data or the adapted image data is to be used as input data for the image inference means.

12. The inspection device according to claim 5, further comprising:
selection means for determining which of the first image data or the adapted image data is to be used as input data for the image inference means.

13. The inspection device according to claim 6, further comprising:
selection means for determining which of the first image data or the adapted image data is to be used as input data for the image inference means.

14. The inspection device according to claim 7, further comprising:
selection means for determining which of the first image data or the adapted image data is to be used as input data for the image inference means.

15. An inspection method of an inspection object by an inspection device including a camera that captures an image of the inspection object to acquire image data and image inference means for outputting a determination result indicating a quality of the inspection object based on the input image data, the inspection method comprising:
a step of acquiring first image data obtained by capturing the image of the inspection object via the camera;
a domain adaptation step of outputting adapted image data, which is adapted to a distribution of learning image data used for model generation by the image inference means, based on the first image data and metadata indicating a distribution of the first image data; and
an image inference step of inputting the adapted image data to the image inference means and outputting the determination result indicating the quality of the inspection object.

16. The inspection method according to claim 15,
wherein the metadata includes information indicating a capturing condition in a case where the camera captures the image of the inspection object.

17. The inspection method according to claim 16,
wherein the information indicating the capturing condition includes a value indicating characteristics of a light source in a case of capturing the image of the inspection object or a setting value of the camera in a case of capturing the image of the inspection object.
